(19) United States
(12) Patent Application Publication
(10) Pub. No.: US 2006/0147870 A1
(43) Pub. Date: Jul. 6, 2006

(54) Vertical buccal tubes with malleable arresting flaps

(76) Inventor: Pasquale De Simone, Giugliano (IT)

Correspondence Address: Pasquale De Simone;Via Staffetta, 85 Lago Patria, Giugliano (NA), I 80014, IT

(21) Appl. No.: 10/544,387

(22) PCT Filed: Jan. 30, 2004
(86) PCT No.: PCT/IT04/00029

§ 371 Date: Aug. 3, 2005

(30) Foreign Application Priority Data
Feb. 6, 2003 (IT) NA2003A000003
Apr. 9, 2003 (IT) NA2003A000018

(51) Int. Cl. A61C 3/00

(52) U.S. Cl. 433/17

(57) ABSTRACT

Universal Vertical Hinge (UVH) made of malleable steel soldered directly on the lingual surface of an orthodontic band, the UVH is composed by an horizontal ground body (3, 5) and two vertical malleable arresting flaps (1, 2). The ground body has got a swelling (4) in its centre for the vertical insertion of the final part of the PD arch, called vertical bayonet Said two vertical malleable arresting flaps which hold the PD arch, can be straightened and re-folded several times so the PD arch can be removed in a vertical way.

### BACKGROUND ART

Before of the Orthodontic Programmed PD System innovation, the previous status of the technique was based on the use of common orthodontic brackets by vertical or horizontal insertion, to make any orthodontic device made to measure and/or pre-formed, removable from the orthodontic bands fixed on the teeth.

Then the previous technique was based on the use of Bi-Helix (lingual arch) and of Quad Helix (palatine arch), to control the transversal diameter of the dental arches.

Other kinds of orthodontic brackets by vertical insertion allow the insertion of any orthodontic device, but they are not compatible with the PD Arches.

The main disadvantages, in fact, caused by the use of common hinges and brackets are: the instability of the devices, that is sort of swinging, followed by an inconvenient disconnection of the orthodontic devices, the shape incompatibility of common devices by vertical disconnection with the Universal Vertical Hinge, and un-convenient activation to get the searched dental movement.

### DISCLOSURE OF INVENTION

The PD System is a biomechanical system made of unique and innovating orthodontic devices such as:
PD Lingual Arches;
PD Palatine Arches;
Universal Vertical Hinge (UVH), that allows the vertical insertion of PD arches into the molar bands.

The PD lingual arch, the PD palatine arch and the Universal Vertical Hinge are also called Orthodontic Programmed PD System, since they represent the PD System mechanical elements It has been conceived and achieved for “the planned control of the orthodontic expansion” on the dental arches and, in particular, it aims to help the specialist in his profession, through a mechanical system in 4D (time included), compatible with therapeutic and biological individual needs.

The technical design of PD devices foresees:
A mechanical combination system of different elements with the possibility of vertical insertion of the PD arches to the molar bands by the UVH.
A searched molar movement by an aimed and planned movement, with a Set-up support about the teeth to be moved, and by the expansion movement on the model.
The control on the inter-premolar and inter-molar diameter in short times.
The control on the molars torque movement.

The main advantage is a convenient management of PD devices which allows the specialist first the vertical insertion of the PD arches into the molar bands, and this is made easy by the use of the UVH, and second the advantage of an extra-oral pre-activation of PD arches, planned by the specialist decision, achieved in laboratory by a Set-up support, in the respect of the anchorage principle and according to the therapeutic needs.

A detailed description of the PD different mechanical elements continues with the UVH description and with the PD Lingual and PD Palatine Arches description.

The UVH is a new kind of orthodontic hinge, made of malleable steel, which is soldered directly on the lingual surface of the orthodontic bands through the orthodontic welder.

The UVH holds all PD Lingual and PD Palatine Arches made from orthodontic steel wires with a 0.9 mm diameter; so its feature is to guarantee their block and to make them removable in a vertical way.

It is composed by: a ground body and two arresting flaps, which hold the devices.

The ground body has got a swelling in its centre, necessary for the insertion of the final part of the PD arch, called vertical bayonet.

Instead, the two malleable arresting flaps, which hold the device, can be straightened and re-folded more times; in this way we will get a fixed orthodontic device that can be removed from the specialist in a vertical way.

This new kind of hinge is universal for two reasons: first, for its two arresting flaps, since it can be linked to the right-side molars and to the left-side molars of the same arch, so it is ambidextrous; second it can hold any PD lingual and PD palatine arch.

They are new kinds of orthodontic arches with particular shapes. There are different models, symmetrical and unsymmetrical, according to the therapeutic individual needs and according to the control to be made on the searched transversal diameter. The PD lingual arch symmetrical model with two spirals using back-incisor resin; the unsymmetrical model with a right spiral, with right working side and the opposite for the anchorage; the unsymmetrical model, with a left spiral, with left working side and the opposite for the anchorage; the PD palatine arch symmetrical model with four spirals using back-incisor resin; the unsymmetrical model, with two right spirals, with right working side and the opposite for the anchorage; the unsymmetrical model, with two left spirals, with left working side and the opposite for the anchorage.

There is also the possibility to substitute the spirals with shutters, to guarantee a major stability as in the case of the PD supporting arch: a PD simple supporting arch, applicable to the upper and to the lower arch in combination with the UVH.

Other models of PD arches with shutters are: the PD lingual arch symmetrical model with two shutters using back-incisor resin; the unsymmetrical model, with a right shutter, with right working side and the opposite for the anchorage; the unsymmetrical model, with a left shutter, with left working side and the opposite for the anchorage.

The PD palatine arch symmetrical model, with four shutters using back-incisor resin; the unsymmetrical model, with two 100 right shutters, with right working side and the opposite for the anchorage; the unsymmetrical model, with two left shutters, with left working side and the opposite for the anchorage.

Finally all types of PD Arches have got a particular final part shape: a double folding of the wire, called vertical bayonet, which allow the arch to be inserted directly into the UVH, soldered on the molar bands.

### DESCRIPTION OF DRAWINGS

All PD System drawings are contained in five sheets.

The ⅕ sheet includes 4 figures:

FIG. 1: Universal Vertical Hinge—frontal sight;
Part. 1: flap
Part. 2: flap
Part. 3, 5: ground body
Part. 4: central swelling

FIG. 2: “ “ “ —first side sight;

FIG. 3: “ “ “ —second side sight;

FIG. 4: “ “ “ —ground sight.

The ⅖ sheet includes 8 figures, showing the combination among different elements, such as UVH, PD lingual arch, PD palatine arch, PD supporting arch and a common molar band.

FIG. 1: UVH;

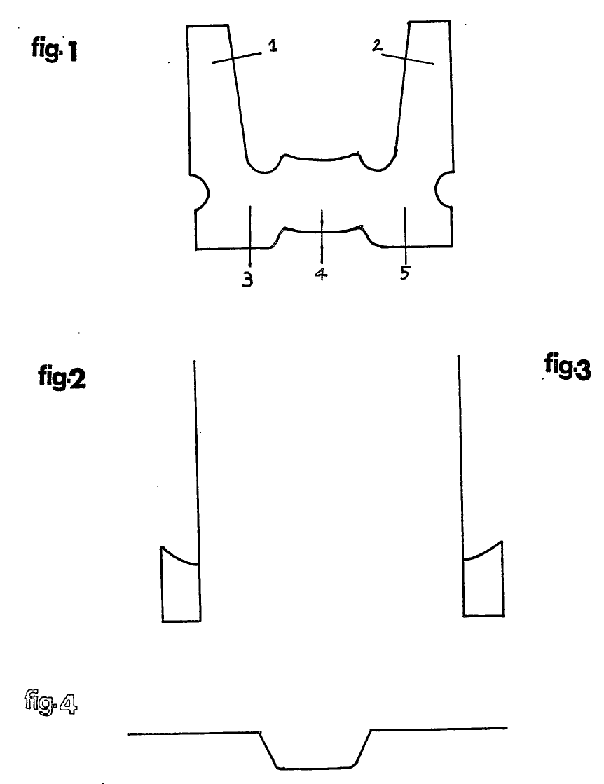

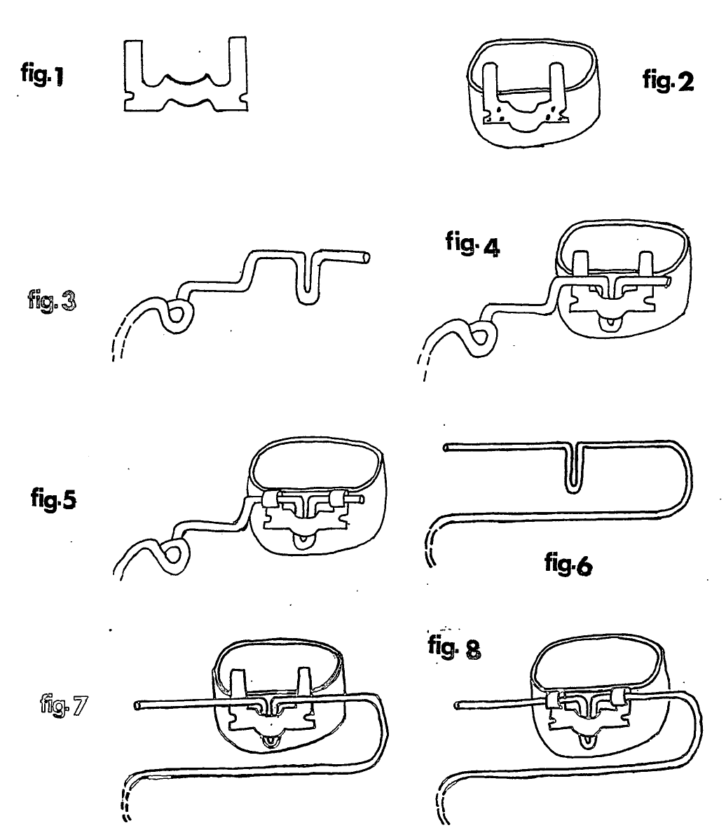

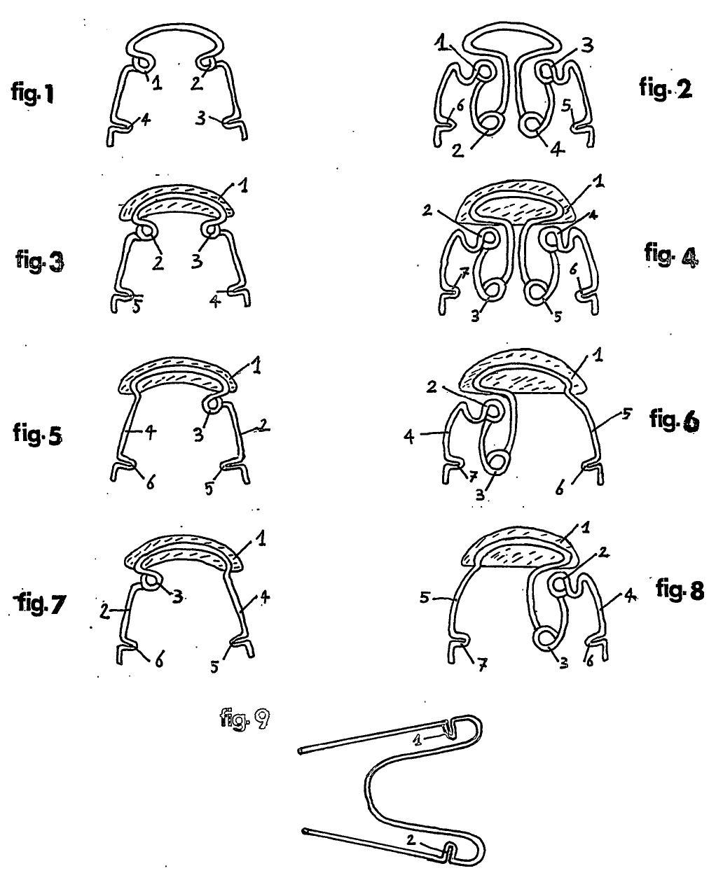

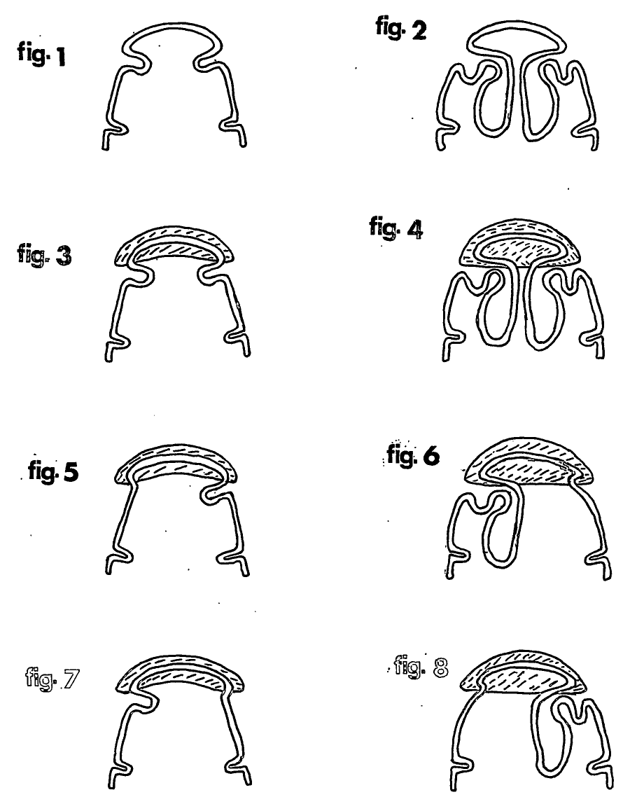

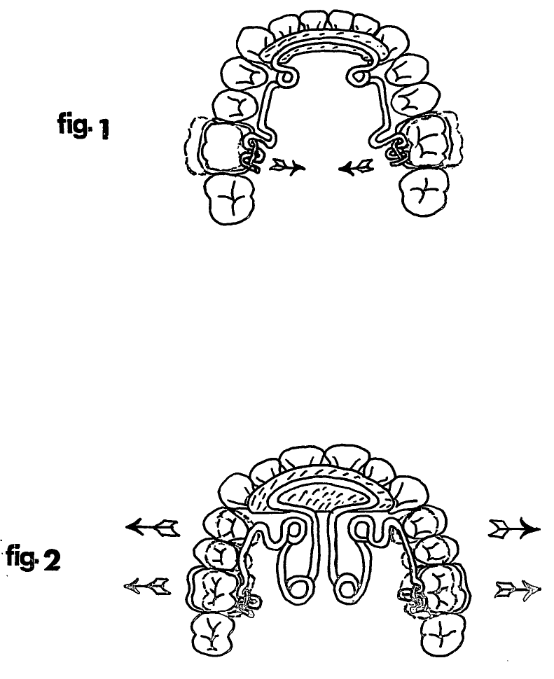

FIG. 2: UVH soldered on a common molar band;

FIG. 3: final part of PD lingual and PD palatine arch, called vertical bayonet;

FIG. 4: vertical bayonet connected into the UVH swelling;

FIG. 5: block of the arch, by folding the two arresting flaps;

FIG. 6: final part of the PD supporting arch, called vertical bayonet;

FIG. 7: vertical bayonet of the PD supporting arch, connected into the UVH swelling;

FIG. 8: block of the PD supporting arch, by folding the two arresting flaps.

The ⅗ sheet includes 9 figures, showing the PD lingual and PD palatine arch and PD supporting arch.

FIG. 1: PD lingual arch with spirals and without resin;
Part. 1 and Part. 2: spirals
Part. 3 and Part. 4: vertical bayonets

FIG. 2: PD palatine arch with spirals and without resin;
Part. 1, 2, 3, 4: spirals
Part. 5, 6: vertical bayonets

FIG. 3: PD lingual arch with spirals and with resin;
Part. 1: resin
Part. 2,3. spirals
Part. 4,5: vertical bayonets

FIG. 4: PD palatine arch with spirals and with resin;
Part. 1 resin
Part. 2, 3, 4, 5: spirals
Part. 6, 7: vertical bayonets

FIG. 5: Right unsymmetrical PD lingual arch;
Part. 1: resin
Part. 2: right working side
Part. 3: right spiral
Part. 4: opposite side for the anchorage
Part. 5, 6: vertical bayonets

FIG. 6: Right unsymmetrical PD palatine arch;
Part. 1: resin
Part. 2, 3: right spirals
Part. 4: right working side
Part. 5: opposite side for the anchorage
Part. 6, 7: vertical bayonets

FIG. 7: Left unsymmetrical PD lingual arch;
Part. 1: resin
Part. 2: left working side
Part. 3: left spiral 1
Part. 4: opposite side for the anchorage
Part. 5, 6: vertical bayonets

FIG. 8: Left unsymmetrical PD palatine arch;
Part. 1: resin
Part. 2, 3: left spirals
Part. 4: left working side
Part. 5: opposite side for the anchorage
Part. 6, 7: vertical bayonets

FIG. 9: PD supporting arch;
Part. 1, 2: vertical bayonets

The ⅘ sheet includes 8 figures, showing PD lingual and PD palatine arch with shutters.

FIG. 1: PD lingual arch with two shutters;

FIG. 2: PD palatine arch with four shutters;

FIG. 3: PD lingual arch with two shutters and with resin;

FIG. 4: PD palatine arch with four shutters and with resin;

FIG. 5: Right unsymmetrical PD lingual arch with one shutter and with resin;

FIG. 6: Right unsymmetrical PD palatine arch with two shutters and with resin;

FIG. 7: Left unsymmetrical PD lingual arch with one shutter and with resin;

FIG. 8: Left unsymmetrical PD palatine arch with two shutters and with resin.

The 5/5 sheet includes 2 figures, showing the planned dental movement by PD arches and by UVHs soldered on the molar bands.

The arrows stand for the verse of the dental movement, while the outlines stand for the previous dental position.

FIG. 1: Application on the lower dental arch of PD lingual arch, with UVHs, and with and aimed and planned expansion;

FIG. 2: Application on the upper dental arch of PD palatine arch, with UVHs, and with an aimed and planned expansion.

### BEST MODE FOR CARRYING OUT THE INVENTION

The aim of the Universal Vertical Hinge is that to reach a major stability, compared with other hinges, totally avoiding the swinging of the orthodontic devices, that the hinge is meant to hold.

The UVH guarantees:
Total Anchorage, with the possibility of vertical disconnection of the PD orthodontic devices held in it.
Convenience in using it, because of the great stability of the orthodontic devices held in it, and because of the convenient disconnection of the orthodontic devices from the bands.

The aim of PD arches is that to get the control of the inter-molar diameter, that is transversal, of the dental arches, through a planned expansion movement, by a technical Set-up support, which guarantees to plan the searched dental movement, respecting the Total Anchorage principle.

Thus the use of an orthodontic resin in the back-incisor zone allows the control on the lower dental arch for the Total Anchorage of the PD lingual arch, while the control on the upper dental arch for the Total Anchorage of the PD palatine arch.

The results have pointed out interesting advantages, comparing with common brackets, hinges and common arches, already used in Orthodontotechnics.

The main results are: the planned control of the orthodontic expansion of the dental arches, by an aimed and planned dental movement; an improvement in the Anchorage principle and in the stability of the orthodontic devices, thus guaranteeing a great precision of the device and of the management times.

### INDUSTRIAL APPLICABILITY

The Universal Vertical Hinge with its original shape can be reproduced without changing its typical features while all types of PD Arches models can be made in a standard way, but during their application they are adjusted according to the different therapeutic individual needs.

For this reason the Orthodontic Programmed PD System (UVH and PD arches), can be proposed to the whole industrial production, according the dictates foreseen by law.

1) The Orthodontic Programmed PD System (Universal Vertical Hinge and PD Arches) claims its aims and purposes described in the preceding pages.

2) The Orthodontic Programmed PD System claims its combination of PD Lingual Arches and PD Palatine arches, in all their shapes and models, with the Universal Vertical Hinge.

3) The Universal Vertical Hinge claims its features of the ground swelling body, holding the final part called vertical bayonet, of every PD arch, made from orthodontic steel wire with a 0.9 mm diameter.

4) The Universal Vertical Hinge claims its two malleable arresting flaps, which allow the orthodontic devices to be blocked, respecting the Total Anchorage, with the possibility to straighten and to re-fold them more times, so that the device is removable in a vertical way.

5) The PD Arches claim their use of orthodontic resin in the back-incisor zone and its advantages, always respecting the Anchorage principle.

6) The Universal Vertical Hinge claims its convenience for the specialist to manage the orthodontic devices held in it, for the reasons described above (3^{rd} claim).

7) The PD Arches claim its convenience to be used because of the vertical insertion of the devices, by the Universal Vertical Hinge.

8) The PD Arches claim their planned and aimed extra-oral pre-activation, by a searched dental movement through the Set-up support.

9) The Universal Vertical Hinge claims its features of being ambidextrous for it has got two malleable arresting flaps, so it can be linked to the right-side molars bands and left-side molars bands of the same arch.

10) The PD Arches claim their planned control on the transversal diameter of the dental arches.
